(19) United States
(12) Patent Application Publication
(10) Pub. No.: US 2025/0379505 A1
(43) Pub. Date: Dec. 11, 2025

(54) METHOD AND APPARATUS FOR OPERATING POWER ELECTRONICS, POWER ELECTRONICS

(71) Applicant: Robert Bosch GmbH, Stuttgart (DE)

(72) Inventors: Daniel Schweiker, Ludwigsburg (DE); Daniel Raichle, Vaihingen (DE); Thomas Knorpp, Murr (DE)

(21) Appl. No.: 18/872,985

(22) PCT Filed: Apr. 13, 2023
(86) PCT No.: PCT/EP2023/059668

§ 371 Date: Dec. 9, 2024

(30) Foreign Application Priority Data
Jun. 10, 2022 (DE) 10 2022 205 912.3

(51) Int. Cl. H02M 1/088; H02M 1/32

(52) U.S. Cl. CPC H02M 1/088; H02M 1/322

(57) ABSTRACT

The invention relates to a method for operating power electronics (1), in particular of an inverter or rectifier, the at least one half bridge (2) having two semiconductor switches (3, 4) connected in series, and at least one DC link capacitor (6) connected in parallel to the series connection of semiconductor switches (3, 4) wherein, to perform a discharging operation for electrically discharging the at least one DC link capacitor (6), the two semiconductor switches (3, 4) are activated to generate a plurality of discharge pulses such that they are simultaneously switched to conductive for each discharge pulse for a predetermined duration (tₒₙ), characterized in that in that the semiconductor switches (3,4) are activated as a function of an electrical DC link voltage of the power electronics (1) applied to the DC link capacitor (6), such that the pulse energy (E) of the discharge pulses of the discharging process is equal or nearly equal.

### BACKGROUND

The invention relates to a method for operating power electronics, in particular of an inverter or rectifier, that comprises at least one half bridge having two semiconductor switches connected in series and at least one DC link capacitor connected in parallel to the semiconductor switch series connection, wherein to carry out a discharge operation for electrically discharging the at least one DC link capacitor, the two semiconductor switches for generating a plurality of discharge pulses are activated in such a way, that they are conductive simultaneously for each discharge pulse for a predetermined length of time.

Furthermore, the invention relates to an apparatus for operating such power electronics, which is characterized by a control device that is specially designed to carry out the method indicated above.

Further, the invention relates to power electronics, in particular as described above, comprising the above-mentioned apparatus.

Furthermore, the invention relates to a computer program, a machine-readable storage medium, a drive train and a vehicle.

Methods and apparatuses of the aforementioned type are already known from the prior art. In order to discharge the DC link capacitor or the DC link circuit, short-circuiting a half bridge is known, in which both semiconductor switches, in particular the semiconductor switch to the positive high voltage potential and the semiconductor switch to the negative high voltage potential, are simultaneously switched to conductive. In particular, it is known to switch on a so-called soft short circuit, in which one of the semiconductor switches is turned on fully and the other semiconductor switch is turned on slowly using an increased gate resistor. According to the gate voltage of the other semiconductor switch, there is a half bridge cross current which discharges the capacitance of the DC link, in particular the DC link capacitor. This cross current is reacted in short pulses, so-called discharge pulses, which in the past have been repetitively reacted at a fixed clock frequency. A power dissipation produced in this case drops via the semiconductor switch, which slowly levels out and thus carries the full DC link voltage at this time of the discharge pulse.

### SUMMARY

The method according to the invention with the features of the disclosure has the advantage that the DC link or DC link capacitor is discharged faster than before. According to the present invention, it is provided for this purpose that the semiconductor switches are actuated depending on an electrical DC link voltage of the power electronics such that the respective pulse energy of the discharge pulses of the discharging process is equal or nearly the same. It is thus contemplated that each of the discharge pulses within a discharging process have the same or nearly the same pulse energy, at least within this discharging process. Each discharge pulse within the discharging process thus results in the same or nearly the same pulse energy. This results in the advantage that even at low DC link voltages, the pulse energy utilizes the full potential of the power electronics, thus accelerating the discharging process, as well as preventing overloading of the power electronics at high voltages.

According to a preferred embodiment of the invention, the duration of the respective discharge pulse is predetermined as a function of the current DC link voltage. The pulse energy of the respective discharge pulse is thus set as a function of the current DC link voltage. Thus, the respective discharge pulse receives the same discharge energy as the previous or subsequent discharge pulse, or nearly the same energy.

Furthermore, it is preferably provided that the duration is predetermined by a previously stored characteristic curve as a function of the DC link voltage. The characteristic curve is in particular stored in a non-volatile memory of a control unit or a control device, for example the power electronics. The characteristic curve specifies the duration of the respective discharge pulse as a function of the current DC link voltage. This ensures that the discharge pulse is set safely with optimized discharging energy until the DC link voltage is drained.

According to a preferred embodiment of the invention, the duration of the respective discharge pulse is predetermined as a function of a target current flowing through the half bridge at each discharge pulse. The pulse energy of the respective discharge pulse is thus set as a function of the target current and the current DC link voltage. Thus, the respective discharge pulse receives the same discharge energy as the previous or subsequent discharge pulse, or nearly the same energy.

Furthermore, it is preferably provided that the target current is predetermined by a previously stored characteristic curve as a function of the DC link voltage. The characteristic curve is in particular stored in a non-volatile memory of a control unit or a control device, for example the power electronics. The characteristic curve specifies the target current for the respective discharge pulse as a function of the current DC link voltage. This ensures that the discharge pulse is set safely with optimal discharging energy until the DC link voltage is drained.

Particularly preferably, the characteristic curve is determined by prior experiments and/or calculations and then stored as described above. The characteristic curve can also be realized in the form of a look-up table.

According to a further embodiment of the invention, it is preferably provided that the actual current is sensed via feedback. This makes it possible to compare and regulate the set current against the target current. The duration of the discharge pulse is in turn used as the control variable. If the target current has been programmed via a characteristic curve in accordance with the above advantageous embodiment, it is thereby possible to adjust the pulse energy significantly more precisely.

Furthermore, it is preferably provided that the respective pulse width or duration is determined as a function of a pre-charge duration of a gate driver of the respective semiconductor switch. Each semiconductor switch is typically associated with a device driver, by which the respective semiconductor switch is switched to conductive or non-conductive. Because the conductive circuit itself requires a certain amount of time until the threshold voltage of the semiconductor switch is exceeded and the semiconductor switch begins to draw current (this is referred to as the so-called pre-charge duration), this pre-charge duration is taken into account when determining the pulse width in order to approximately determine the actual pulse width or current pulse width. In particular, a set or fixed amount of time corresponding to the pre-charge duration is added to the theoretical pulse width required to achieve the discharge energy. This ensures that the total pulse width comprises both the desired pulse width and the pre-charge duration, so that the desired discharge energy is reliably ensured. The pulse width then corresponds to the total pulse width minus the pre-charge duration.

Furthermore, it is preferably provided that the pulse energy of a discharge pulse reacted in each case is approximated, in particular under the assumption of a delta current signal, and that the pulse width of a charging pulse following this discharge pulse is predetermined as a function of the pulse energy reacted. The duration or pulse width of a discharge pulse is thus set or specified as a function of the pulse energy reacted with a previously, in particular with the directly previously reacted discharge pulse, in order to achieve an optimal result with regard to the accuracy of the pulse energy over variation of the semiconductor parameters. The following formula in particular is used for preferred approximation by means of the delta signal:

$${E}_{p} = \frac{1}{2} \cdot \hat{I} \cdot {V}_{D C} \cdot {t}_{i s t}$$

Here, Eₚ corresponds to the pulse energy of a discharge pulse, Δ to the measured or approximated current peak value, V_{DC} to the current DC link voltage and t_{actual} to the pulse width.

Preferably, an actual charging pulse width or actual duration is detected, in particular by means of a suitable sensor technology, particularly preferably measured, and taken into account for determining the duration for the or a subsequent discharge pulse. Thus, depending on the actual pulse width of a discharge pulse, the duration for the or a subsequent discharge pulse is set to ensure the same or nearly the same pulse energy.

Preferably, to generate a discharging operation, one of the semiconductor switches is switched to be permanently conductive and the other one of the semiconductor switches is actuated repetitively or pulsed. In particular, the semiconductor switch is permanently controlled to the positive high voltage potential in a pulsed manner, and the semiconductor switch is controlled to the negative high voltage potential in a pulsed manner, or vice versa.

The device according to the invention with the features of the disclosure is characterized in that the control device is specifically configured to perform the method according to the invention. This results in the aforementioned advantages.

The power electronics according to the invention with the features of the disclosure are characterized in that the apparatus is configured according to the invention. This results in the aforementioned advantages.

The computer program according to the invention having the features of the disclosure is characterized in that it performs the method according to the invention when it is executed. This, too, results in the aforementioned advantages.

The storage medium according to the invention with the features of the disclosure is characterized by the computer program according to the invention, which can be executed on a computer, for example on a computing unit of a control device.

The drive train according to the invention with the features of the disclosure comprises power electronics as described above, as well as in particular an electrical machine and/or an electrical energy store for supplying electrical energy to the electrical machine. The power electronics operate the drive train pursuant to the method according to the invention. This, therefore, results in the aforementioned advantages.

The vehicle, in particular the motor vehicle having the features of the disclosure comprises the drive train according to the invention.

Further advantages and preferred features and combinations of features result in particular from the previous descriptions and from the claims. The invention will be explained in further detail hereinafter with reference to the drawing.

### BRIEF DESCRIPTION OF THE DRAWINGS

Shown are:

FIG. 1 a simplified illustration of a half bridge in the power electronics,

FIG. 2A a diagram illustrating an advantageous method for operating the power electronics, and

FIG. 2B a diagram illustrating the timing of a discharge pulse,

FIG. 3A a method in which a power pilot is performed as a function of the electrical current,

FIG. 3B an exemplary embodiment of a power control for which a reacted pulse energy is calculated and

FIG. 3C a power control in which a discharge pulse width is measured.

### DETAILED DESCRIPTION

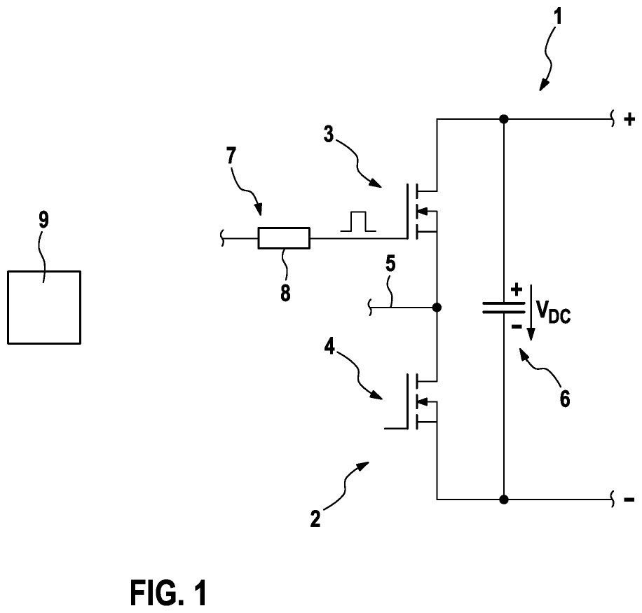

FIG. 1 shows a simplified illustration of power electronics 1, which are configured as an inverter for an electric machine of an electric vehicle, for example. The power electronics 1 comprises a half bridge 2 comprising a first semiconductor switch 3 and a second semiconductor switch 4 connected in series to one other. The first semiconductor switch 3 is, for example, electrically connected to a positive potential of the supply voltage (+), in particular the high voltage, and the second semiconductor switch 4 is connected to a ground terminal or to a negative potential of the supply voltage (−), in particular the high voltage. Between the two semiconductor switches 3, 4, phase 5 of the electric machine, for example U, V or W, is connected. By controlling the semiconductor switches 3, 4, the phase 5 of the electric machine is selectively exposed to an operating current. In parallel to the series connection of the semiconductor switches 3, 4, a DC link capacitor 6 is also connected, via which the supply voltage V_{DC} drops.

Each semiconductor switch 3, 4 is upstream of a so-called gate driver 7, which switches the respective semiconductor switch 3, 4 to be conductive or non-conductive. In the present case, the gate driver 7 is only shown for the semiconductor switch 3.

In order to discharge the DC link capacitor 6, one of the semiconductor switches, previously the semiconductor switch 4, i.e. the low-side semiconductor switch, is fully switched on and another of the semiconductor switches, i.e. the semiconductor switch 3 or the high-side semiconductor switch, is operated by the gate driver 7 in a pulsing or repetitive manner for a predetermined period of time to realize a soft short circuit.

In accordance with a further exemplary embodiment, the low-side semiconductor switch is pulsed and the high-side semiconductor switch is permanently switched on to perform a discharge operation. An increased gate resistor 8 ensures that the semiconductor switch 3 is only switched on slowly. A half bridge cross current is set according to the gate voltage, which discharges the capacity of the DC link capacitor 6 or the entire DC link. This cross current is reacted in short pulses by the activation of the semiconductor switch 3, as indicated in FIG. 1 by a corresponding symbol. The pulses occur in a fixed clock frequency. The resulting power dissipation drops via the first semiconductor switch 3, which carries the full DC link voltage at the pulse point and is operated in linear mode in particular. The energy withdrawn from DC link capacitor 6 is converted into heat in the semiconductor switch 3 and preferably discharged by a cooling system of the power electronics 1. In this case, the problem results that with constant current regulation, when lower voltages of the DC link are reached, the pulse energy no longer utilizes the full potential of the power electronics 1 and at high voltages tends to overload the power module 1.

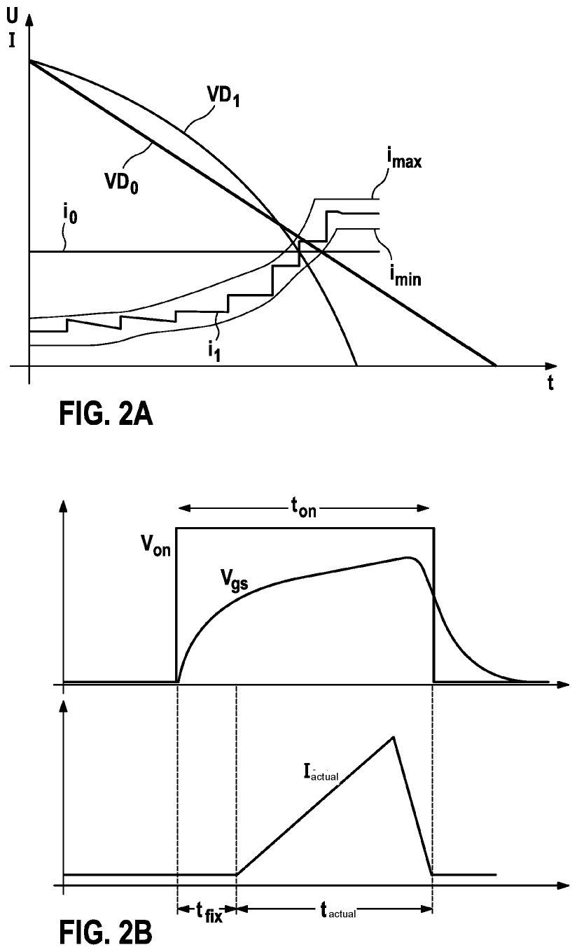

FIG. 2B shows the time curve of the gate voltage signal, as well as the current I of a discharge pulse.

The method described below proposes to approximate the current I of a discharge pulse to r by means of a delta signal according to the following equation:

$${E}_{p} = \frac{1}{2} \cdot \hat{I} \cdot {V}_{D C} \cdot {t}_{i s t}$$

In this case, E_p is the pulse energy, Î the current peak value, V_DC is the DC link voltage, and t_{actual} is the duration of the discharge pulse that has occurred. The equation shows that, if the peak current and pulse width are constant, the pulse energy Eₚ decreases in a linear fashion as the DC link voltage V_DC decreases. A slightly wider charge pulse must be set via the DIBL effect in order to achieve the same current, but this does not have a particularly great impact on the method.

With a voltage-dependent adjustment of the current and thus also the pulse width, a constant pulse energy is set in an advantageous manner for the discharge pulses of a discharge process, whereby the discharging speed of the DC link also increases significantly in the range of lower electrical voltages of the DC link, as shown for example in FIG. 2A. The advantageous method results in an exponentially more rapid decrease of the voltage curve.

FIG. 2A shows a diagram showing current I and voltage U over the time t in order to explain an advantageous method for discharging the DC link. The previous voltage curve VD₀ as well as an advantageous voltage curve with an exponential decrease VD₁ generated by the method described in the following is shown. Likewise, the diagram shows a constant discharge current I₀ as well as a charging current i₁ adjusted by the advantageous method, which runs stepwise between a maximum charging current iₘₐₓ and a minimum charging current iₘᵢₙ.

According to a first exemplary embodiment of the advantageous method, the pulse energy is piloted by tracking the charging current i₁ as a function of the currently applied DC link voltage VD₁. In particular, a characteristic curve is stored in a non-volatile memory of a control device 9, which activates the power electronics 1 and is in particular part of the power electronics 1. The characteristic curve is selected such that it specifies the target current or target current range (iₘᵢₙ−iₘₐₓ) and thus, the pulse energy E of the discharge pulses is kept equal or approximately the same with a higher peak current to smaller DC link voltage V_{DC}. The current is thus tracked such that the same pulse energy is always drawn from the DC link with each discharge pulse. Because the energy in the DC link capacitor 6 drops in a quadratic manner with decreasing voltage V_{DC}, an exponential discharging characteristic of the half bridge 2 results as shown by curve VD₁.

According to a second exemplary embodiment, the pulse energy E reacted is controlled to a target value according to the above-mentioned approximation formula. For this purpose, the pulse width of the respective discharge pulse, i.e. the predetermined duration, is used as the variable and the current level of the respective discharge pulse is thus varied. In particular, a current voltage value of the DC link voltage V_{DC}, the current peak Iₚₑₐₖ and the current pulse width tactual are determined in the control device 9, in particular in a computing unit of the control device 9. For the pulse width tactual, the activation time of the output discharge pulse minus a fixed length of time t_{fix}, which corresponds to the time elapsed for pre-charging the gate of the activated semiconductor switch 3 without current flowing through the semiconductor switch 3, is predetermined. The pre-charge duration t_{fix} is thus considered in order to determine the actual pulse width: t_{actual}=tₒₙ−t_{fix}

Because different batches of semiconductors 3, 4 can have different transfer characteristics, these deviations are compensated for with the advantageous consideration of the pulse width by regulating them to the constant or the same pulse energy E. Thus, all devices receive approximately the same discharge time despite the deviating transfer characteristics of individual semiconductor switches.

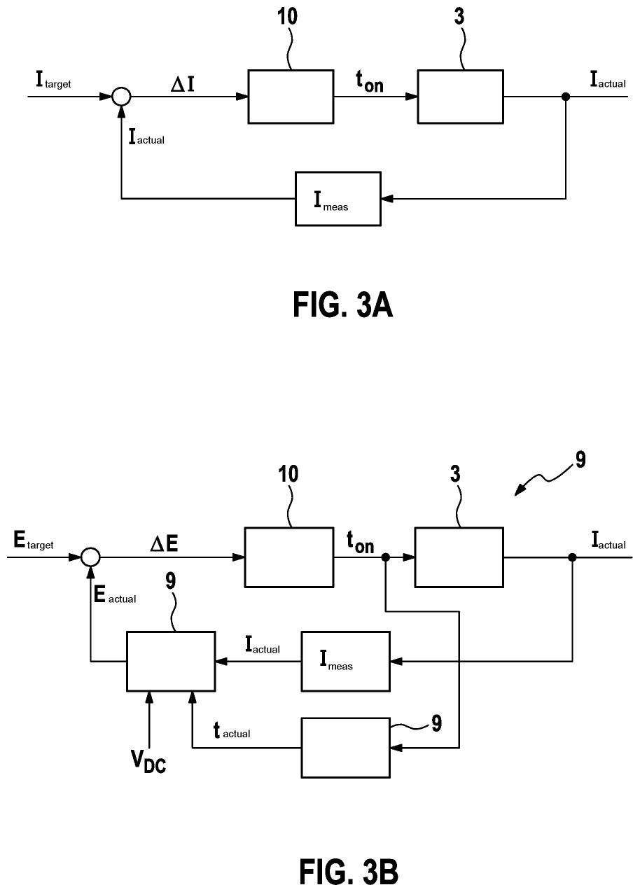

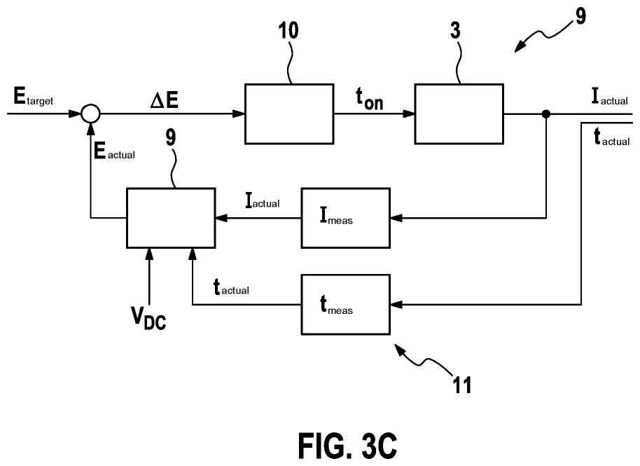

FIGS. 3A to 3C show control loops to explain and summarize the methods described above.

According to the exemplary embodiment of FIG. 3A, the actual current I_{actual} set is regulated as a function of the target current I_{target}. First, the current DC link voltage V_{DC} is measured and the associated target current I_{target}=f(V_{DC}) is determined in the form of a control window of Iₘᵢₙ and Iₘₐₓ, as previously described. Depending on the control difference between I_{actual}−I_{target}, the new target pulse width or the duration tₒₙ is adjusted, at least insofar as the actual current leaves the control window between the minimum current Iₘᵢₙ and the maximum current Iₘₐₓ. Then, preferably, the time period tₒₙ is decremented or incremented. The discharge pulse is then provided by the control device by activation, in particular of the semiconductor switch 3. The flowing discharging current I_{actual} is measured (Iₘₑₐₛ) and the control loop for the following pulse or the subsequent discharge pulse is returned. In particular, the target current is compared with the actual current by a comparator 10 of control unit 9 and the pulse duration tₒₙ is determined for the subsequent discharge pulse.

According to the exemplary embodiment of FIG. 3B, the target pulse energy E_{target} is used as the basis for the power control, wherein the actual duration and the actual pulse width t_{actual}, are taken into account respectively. In this case, the duration tₒₙ is determined or predetermined as a function of the pulse energy for the subsequent pulse and is provided by the actuator or the control device 9, in particular the semiconductor switch 3. The flowing actual current of the semiconductor bridge 2 I_{actual} is measured as in the previous exemplary embodiment. In addition, the actual pulse width or the actual duration of the discharge pulse t_{actual} is also calculated. In particular, the actual set pulse width is calculated using the equation described above from the actual total set pulse width tₒₙ and the pre-charge duration t_{fix}. Depending on the actual current and the actual duration t_{actual}, the last pulse energy E_{actual} set is in particular calculated as a function of the DC link voltage V_{DC} by the control device 9 and returned to the regulation. Depending on the pulse energy detected or calculated, the duration for the next discharge pulse tₒₙ is now determined taking into account the minimum energy Eₘᵢₙ and the maximum energy Eₘₐₓ. Here, preferably the pulse width is set to a power control window. If the calculated energy value is not between the minimum energy Eₘᵢₙ and the maximum energy Eₘₐₓ, preferably the pulse duration tₒₙ is incremented or decremented.

FIG. 3C shows a further exemplary embodiment that differs from the previous exemplary embodiment in that the actual pulse duration tactual is not calculated but rather measured tₘₑₐₛ. For this purpose, for example, a sensor device 11 is used that monitors or measures the pulse duration t_{actual_meas} of the set discharge pulse and that is based on the calculation of the pulse energy Eactual reacted. Even more precise control of the pulse energy is thus possible and any unknown influences caused by semiconductor properties or unknown semiconductor parameters can be balanced out.

1. A method for operating power electronics (1) of an inverter or rectifier that comprises at least one half bridge (2) having two semiconductor switches (3,4) and at least one DC link capacitor (6) connected in parallel to the series connection of the semiconductor switches (3,4) the method comprising: performing a discharging operation for electrically discharging the at least one DC link capacitor (6) by activating the two semiconductor switches (3,4) to generate a plurality of discharge pulses, such that the semiconductor switches (3,4) are switched to be conductive for each discharge pulse for a predetermined period of time (tₒₙ), and controlling the semiconductor switches (3,4) as a function of an electrical DC link voltage of the power electronics (1) applied to the DC link capacitor (6), such that the pulse energy (E) of the discharge pulses of the discharging process is equal or nearly equal.

2. The method according to claim 1, wherein the duration (tₒₙ) of the respective discharge pulse of the discharging process is specified as a function of the DC link voltage or a target current (l_{target}) flowing through the half bridge (2) at each discharge pulse.

3. The method according to claim 2, wherein the duration or the target current (I_{target}) is predetermined by a previously stored characteristic curve as a function of the DC link voltage (V_{DC}).

4. The method according to claim 3, wherein the characteristic curve is determined in advance by tests and/or calculations and stored in a non-volatile memory of the power electronics (1).

5. The method according to claim 1, wherein the target current (I_{target}) is predetermined as a function of an actual current (I_{actual}) flowing through the half bridge (2).

6. The method according to claim 5, wherein the respective duration (tₒₙ) is specified as a function of a pre-charge duration (t_{fix}) of a gate driver (7) of the respective semiconductor switch (3).

7. The method according to claim 1, wherein the respective pulse energy (E_{actual}) reacted of a discharge pulse is approximated by means of a delta signal, and that the predetermined duration (tₒₙ) of a discharge pulse following this discharge pulse is predetermined as a function of the pulse energy (E_{actual}) reacted.

8. The method according to claim 1, wherein an actually achieved discharge pulse width is detected (t_{actual}), and the duration (tₒₙ) is taken into account.

9. An apparatus for operating power electronics (1), wherein the power electronics (1) comprise at least one half bridge (2) with two semiconductor switches (3,4) connected in series and at least one DC link capacitor (6) connected in parallel to the series circuitry (3,4), and the apparatus comprises a control device (9) configured to
control a discharging operation for electrically discharging the at least one DC link capacitor (6) by activating the two semiconductor switches (3,4) to generate a plurality of discharge pulses, such that the semiconductor switches (3,4) are switched to be conductive for each discharge pulse for a predetermined period of time (tₒₙ), and
control the semiconductor switches (3,4) as a function of an electrical DC link voltage of the power electronics (1) applied to the DC link capacitor (6), such that the pulse energy (E) of the discharge pulses of the discharging process is equal or nearly equal.

10. Power electronics (1) comprising at least one half bridge (2) having two semiconductor switches (3,4) connected in series and at least one DC link capacitor (6), characterized bycomprising an apparatus according to claim 9.

11. (canceled)

12. A non-transitory, computer-readable storage medium containing instructions that when executed by a computer cause the computer to
operate power electronics (1) of an inverter or rectifier that comprises at least one half bridge (2) having two semiconductor switches (3,4) and at least one DC link capacitor (6) connected in parallel to the series connection of the semiconductor switches (3,4) by controlling:
a discharging operation for electrically discharging the at least one DC link capacitor (6) by activating the two semiconductor switches (3,4) to generate a plurality of discharge pulses, such that the semiconductor switches (3,4) are switched to be conductive for each discharge pulse for a predetermined period of time (tₒₙ), and
the semiconductor switches (3,4) as a function of an electrical DC link voltage of the power electronics (1) applied to the DC link capacitor (6), such that the pulse energy (E) of the discharge pulses of the discharging process is equal or nearly equal.

13. A drive train comprising power electronics according to claim 10.

14. (canceled)
